(19) United States
(12) Patent Application Publication
(10) Pub. No.: US 2026/0175583 A1
(43) Pub. Date: Jun. 25, 2026

(54) LIQUID DISCHARGE APPARATUS

(71) Applicants: Shota UTSUMI, Kanagawa (JP); Akihiro SHIMA, Kanagawa (JP)

(72) Inventors: Shota UTSUMI, Kanagawa (JP); Akihiro SHIMA, Kanagawa (JP)

(21) Appl. No.: 19/419,253

(22) Filed: Dec. 15, 2025

(30) Foreign Application Priority Data
Dec. 24, 2024 (JP) 2024-227068

(51) Int. Cl. B41J 2/165; B41J 2/18; B41J 2/20; B41J 2/21; B41J 11/00

(52) U.S. Cl. CPC B41J 2/16526; B41J 2/18; B41J 2/20; B41J 2/2103; B41J 2/2135; B41J 2/2142; B41J 11/0095

(57) ABSTRACT

A liquid discharge apparatus includes a conveyor to convey a recording medium, a liquid discharge device including a liquid discharge head having multiple nozzles to discharge a liquid. The circuitry selects one of multiple dummy discharge patterns to discharge the liquid from a part of the multiple nozzles to one of non-image forming areas to perform a part of a dummy discharge operation; switches the multiple dummy discharge patterns: from one of the multiple dummy discharge patterns; to another of the multiple dummy discharge patterns, to discharge the liquid from another part of the multiple nozzles to perform another part of the dummy discharge operation; and alternately repeats an image forming operation and the dummy discharge operation to discharge the liquid from all the multiple nozzles with all the multiple dummy discharge patterns to complete one cycle of the dummy discharge operation.

### CROSS-REFERENCE TO RELATED APPLICATION

This patent application is based on and claims priority pursuant to 35 U.S.C. § 119(a) to Japanese Patent Application No. 2024-227068, filed on Dec. 24, 2024, in the Japan Patent Office, the entire disclosure of which is hereby incorporated by reference herein.

### BACKGROUND

### Technical Field

The present disclosure relates to a liquid discharge apparatus.

### Related Art

In the related art, a liquid discharge apparatus includes an image forming device to discharge a liquid from multiple nozzles on a liquid discharge head to form images in image forming areas on a recording medium being conveyed by a conveyor based on input image data. Such a liquid discharge apparatus may include a dummy discharge control unit that performs dummy discharge control. In the dummy discharge control, a liquid is discharged from the multiple nozzles to a non-image forming area between the image forming areas in the conveyance direction of the recording medium as a dummy discharge with a predetermined dummy discharge pattern.

### SUMMARY

The present disclosure described herein provides an improved liquid discharge apparatus including a conveyor, a liquid discharge device, and circuitry. The conveyor conveys a recording medium in a conveyance direction. The liquid discharge device includes a liquid discharge head having multiple nozzles. The liquid discharge head discharges a liquid, in a discharge direction orthogonal to the conveyance direction, from the multiple nozzles onto the recording medium conveyed in the conveyance direction. The circuitry causes the liquid discharge head to: discharge the liquid into each of image forming areas on the recording medium, to form an image in each of the image forming areas to perform an image forming operation; and discharge the liquid into every predetermined number of non-image forming areas between the image forming areas in the conveyance direction, to form multiple dummy discharge patterns in each of the non-image forming areas to perform a dummy discharge operation. Further, the circuitry selects one of the multiple dummy discharge patterns to discharge the liquid from a part of the multiple nozzles to one of the non-image forming areas to perform a part of the dummy discharge operation; switches the multiple dummy discharge patterns: from the one of the multiple dummy discharge patterns; to another of the multiple dummy discharge patterns, to discharge the liquid from another part of the multiple nozzles to perform another part of the dummy discharge operation; and alternately repeats the image forming operation and the dummy discharge operation to discharge the liquid from all the multiple nozzles with all the multiple dummy discharge patterns to complete one cycle of the dummy discharge operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an inkjet printer;

FIG. 2 is a functional block diagram illustrating an image forming operation in the inkjet printer of FIG. 1;

FIGS. 3A to 3C are diagrams each illustrating a line head in the inkjet printer of FIG. 1;

FIG. 4A to 4C are diagrams each illustrating a nozzle arrangement of a liquid discharge head in the line head of FIGS. 3A to 3C;

FIG. 5 is a cross-sectional view of a liquid discharge head, taken in the direction (i.e., a conveyance direction A of a recording medium) orthogonal to a nozzle array direction (i.e., a width direction B of the recording medium);

FIG. 6 is a cross-sectional view of the liquid discharge head of FIG. 5, taken in the nozzle array direction (i.e., the width direction B of the recording medium);

FIG. 7 is a cross-sectional view of another liquid discharge head, taken in the direction (i.e., a conveyance direction A of a recording medium) orthogonal to a nozzle array direction (i.e., a width direction B of the recording medium);

FIG. 8 is a cross-sectional view of the liquid discharge head of FIG. 7, taken in the nozzle array direction (i.e., the width direction B of the recording medium);

FIG. 9 is a block diagram illustrating a functional configuration of a controller in an inkjet printer;

FIG. 10 is a block diagram of a higher-level device constructing the controller of FIG. 9;

FIG. 11 is a block diagram of an output control device constructing the controller of FIG. 9;

FIG. 12 is a graph illustrating a relationship between a time interval between dummy discharges and an appropriate number of droplets in one dummy discharge for one nozzle;

FIG. 13 is a diagram illustrating a line flushing operation;

FIG. 14 is a diagram illustrating another line flushing operation;

FIG. 15 is a flowchart of detection control of defective nozzles performed during consecutive image forming operations;

FIGS. 16A and 16B are diagrams each illustrating flushing (FL) patterns suitable for detection control of defective nozzles;

FIGS. 17A and 17B are diagrams each illustrating other FL patterns suitable for detection control of defective nozzles; and

FIG. 18 is a flowchart of a specification process of a defective nozzle in an image inspection device when the detection control of defective nozzles is performed using the FL patterns of FIGS. 17A and 17B.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An inkjet printer, which is a liquid discharge apparatus as an image forming apparatus, will be described below with reference to the drawings. The liquid discharge apparatus described below is an example, and the scope of the present disclosure is not limited to this configuration. For example, the inkjet printer has a full-line type (non-scanning type) configuration as described below, but may have another configuration such as a serial type (scanning type) configuration.

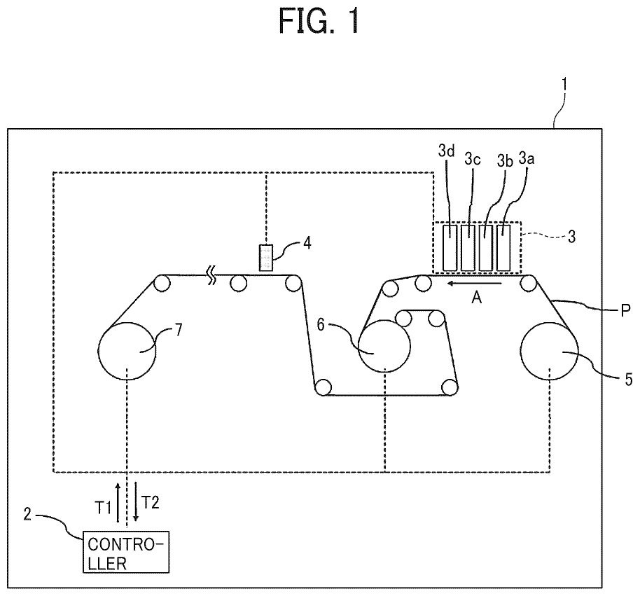

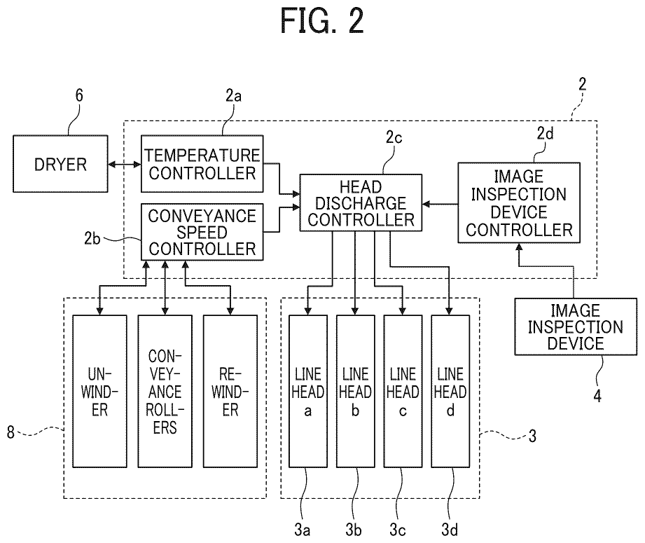

FIG. 1 is a schematic diagram illustrating a configuration of an inkjet printer 1. The inkjet printer 1 includes a feeder 5, a conveyor 8 (see FIG. 2), an image forming device 3, a drum-type dryer 6, an ejector 7, and an image inspection device 4. The feeder 5 feeds a continuous medium P as a recording medium. The conveyor 8 includes conveyance rollers to convey the continuous medium P. The image forming device 3 discharges a liquid onto the continuous medium P conveyed by the conveyor 8 to form an image. The image forming device 3 may be referred to as an image forming unit. The ejector 7 ejects the continuous medium P. The inkjet printer 1 further includes a controller 2 as circuitry.

The continuous medium P is fed from an unwinder of the feeder 5, guided and conveyed by the conveyance rollers of the conveyor 8, and wound by a rewinder of the ejector 7. The continuous medium P is conveyed at the target speed by the rotational drive of the unwinder and the rewinder synchronized by a control signal T1 from the controller 2. The continuous medium P is conveyed to pass through positions facing line heads 3a, 3b, 3c, and 3d of the image forming device 3, and each of the line heads 3a, 3b, 3c, and 3d discharges a liquid from nozzles onto the continuous medium P to form an image.

The line heads 3a, 3b, 3c, and 3d of the image forming device 3 discharge liquids of colors, such as black (K), cyan (C), magenta (M), and yellow (Y), respectively, and are arranged in this color order from the upstream side in a conveyance direction A of the continuous medium P (i.e., a recording medium). Each of the line heads 3a, 3b, 3c, and 3d includes one, or two or more liquid discharge heads. The types of colors and the number of line heads are not limited thereto.

When the continuous medium P passes directly below the image forming device 3, the line heads 3a, 3b, 3c, and 3d discharge the liquids of the respective colors, so that a print pattern based on input image data is printed in a predetermined image forming area to form an image. The formed image passes through the dryer 6 and is fixed onto the continuous medium P, and then the image inspection device 4 inspects the image. The controller 2 receives a reception signal T2 including image inspection data that indicates the inspection results by the image inspection device 4. The controller 2 performs various correction processing using the received image inspection data.

FIG. 2 is a functional block diagram illustrating an image forming operation in the inkjet printer 1. The controller 2 includes a temperature controller 2a, a conveyance speed controller 2b, a head discharge controller 2c, and an image inspection device controller 2d. The temperature controller 2a controls the temperature of the dryer 6. The conveyance speed controller 2b controls the speed of the conveyor 8. As illustrated in FIG. 2, the conveyor 8 includes the unwinder and the rewinder in addition to the conveyance rollers. The head discharge controller 2c inputs a discharge signal to each of the line heads 3a, 3b, 3c, and 3d to discharge a liquid. The image inspection device controller 2d controls the image inspection device 4.

In the image forming operation, first, the temperature controller 2a starts temperature control to adjust the dryer 6 to a desired temperature. Then, the conveyor 8 starts conveying the continuous medium P at the timing when the dryer 6 reaches the desired temperature. When the conveyance speed of the continuous medium P becomes constant at the target speed by the conveyance speed controller 2b and the temperature of the dryer 6 is within a desired temperature range, the head discharge controller 2c inputs the discharge signal to each of the line heads 3a, 3b, 3c, and 3d to form an image on the continuous medium P with the liquid discharged from each of the line heads 3a, 3b, 3c, and 3d.

The timing of liquid discharge from the line heads 3a, 3b, 3c, and 3d is adjusted based on dot positions (positions on the medium at which the discharged liquid lands) of a dot pattern. An adjustment pattern is formed in advance, and an in-line sensor (dot pattern detector) of the image inspection device 4 reads (inspects) the dot pattern in the adjustment pattern to detect the dot positions. In addition, during consecutive image forming operations, the in-line sensor of the image inspection device 4 reads the adjustment pattern formed in a non-image forming area on the continuous medium P, and the image forming operation is performed while adjusting the timing of liquid discharge based on the dot positions of the dot pattern read by the in-line sensor.

The image inspection by the image inspection device 4 includes, for example, detection of a nozzle state (state of the liquid discharge function of the nozzle) of each of the line heads 3a, 3b, 3c, and 3d (e.g., detection of discharge failure). Information on the detected nozzle state (information on the defective nozzle) is used for, for example, a process of notifying a user that a discharge failure of the nozzle has occurred. In addition, the information on the detected defective nozzle is fed back to, for example, non-discharge complementation control (e.g., control of complementing a dot of the defective nozzle by increasing the amount of liquid discharged from the adjacent nozzle adjacent to the defective nozzle). The information on the detected nozzle state is used for a process of, for example, determining which head is to be cleaned at the time of head cleaning.

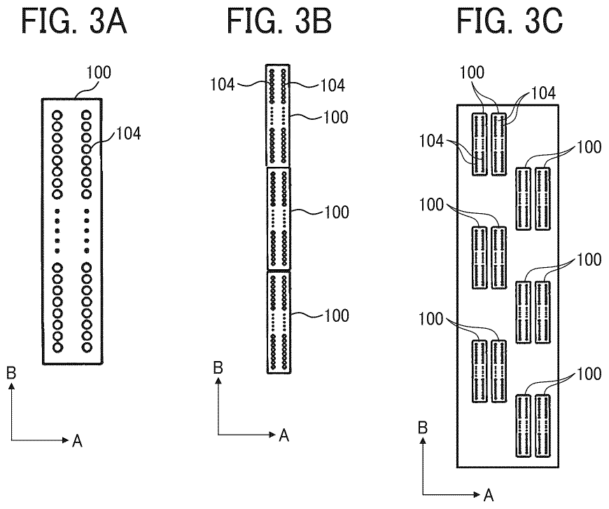

FIGS. 3A to 3C are diagrams each illustrating an example of the line heads 3a, 3b, 3c, and 3d. Each of the line heads 3a, 3b, 3c, and 3d may include one liquid discharge head 100 as illustrated in FIG. 3A, or may include multiple liquid discharge heads 100 as illustrated in FIGS. 3B and 3C. When the line head 3a includes the multiple liquid discharge heads 100, the multiple liquid discharge heads 100 may be arranged linearly in a width direction B of the continuous medium P (i.e., the recording medium) as illustrated in FIG. 3B, or may be arranged in a staggered manner in the width direction B of the recording medium as illustrated in FIG. 3C. As illustrated in FIG. 3C, some of the multiple liquid discharge heads 100 may be arranged in the conveyance direction A of the recording medium.

The line heads 3a, 3b, 3c, and 3d include the liquid discharge head 100 and the head tank that supplies liquid to the liquid discharge head 100. However, the configuration of the line heads 3a, 3b, 3c, and 3d is not limited to such a configuration, and the line heads 3a, 3b, 3c, and 3d may include just the liquid discharge head alone or may include components other than the head tank.

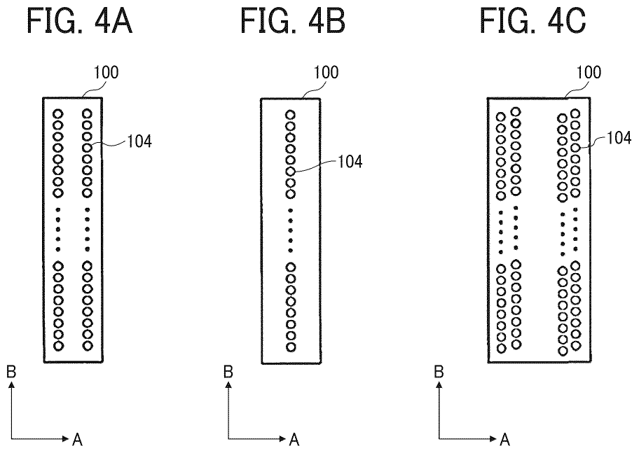

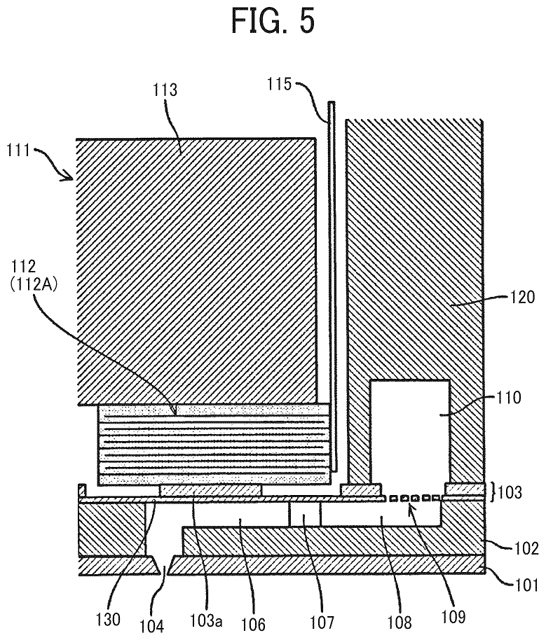

FIG. 4A to 4C are diagrams each illustrating a nozzle arrangement of the liquid discharge head 100. Multiple nozzles 104 are arrayed on a nozzle face of the liquid discharge head 100 to discharge liquid, as illustrated in FIGS. 4A to 4C. The liquid discharge head 100 may have two nozzle arrays each having the multiple nozzles 104 arrayed in line in the width direction B of the recording medium as illustrated in FIG. 4A. Alternatively, the liquid discharge head 100 may have one nozzle array having the multiple nozzles 104 arrayed in line in the width direction B of the recording medium as illustrated in FIG. 4B. Further, the liquid discharge head 100 may have multiple nozzle arrays as illustrated in FIG. 4C, in which the nozzle positions of the nozzle arrays may be shifted from each other in the width direction B of the recording medium between the nozzle arrays.

The shape of the nozzle face of the liquid discharge head 100 may be a polygon, typically, a quadrangle (e.g., a rectangle, a parallelogram, or a trapezoid). Alternatively, for example, the shape of the nozzle face may be obtained by rounding the corners of the polygon, or may be a circle or an ellipse.

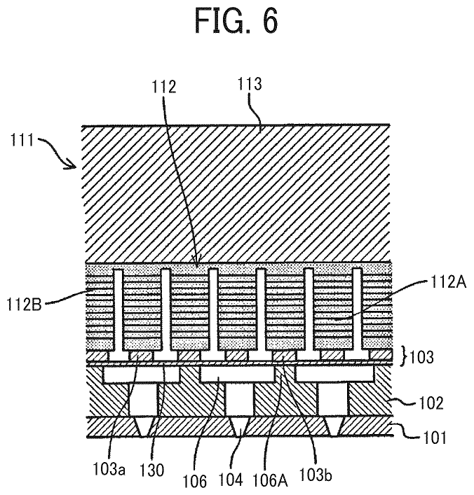

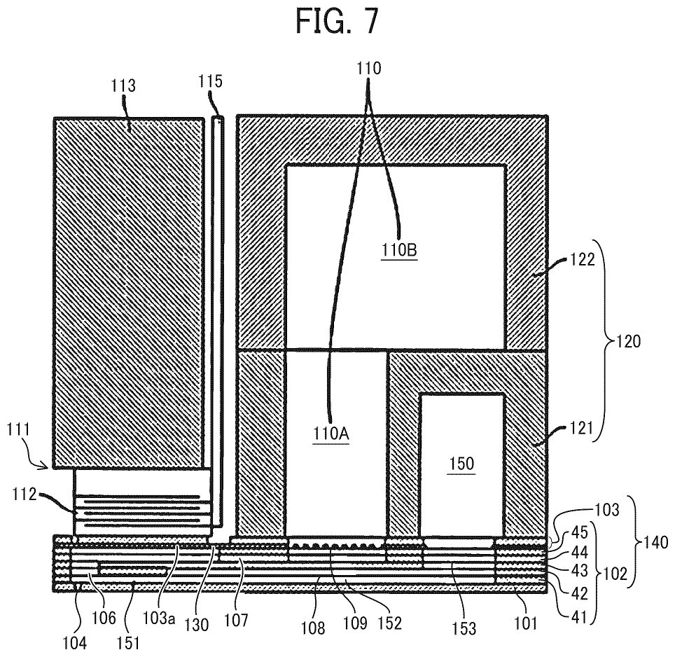

The liquid discharge head 100 is described below with reference to FIGS. 5 and 6. FIG. 5 is a cross-sectional view of the liquid discharge head 100, taken in the direction (i.e., the conveyance direction A of the recording medium) orthogonal to a nozzle array direction (i.e., the width direction B of the recording medium). FIG. 6 is a cross-sectional view of the liquid discharge head 100, taken in the nozzle array direction (i.e., the width direction B of the recording medium).

The liquid discharge head 100 illustrated in FIG. 5 includes a nozzle plate 101, a channel plate (liquid chamber substrate) 102, and a diaphragm 103 that are bonded together. The liquid discharge head 100 further includes a piezoelectric actuator 111 to displace the diaphragm 103 and a frame 120 as a common channel substrate.

Such a configuration defines individual liquid chambers 106, fluid restrictors 107, and liquid inlets 108. The individual liquid chambers 106 may be referred to as pressure chambers or pressurizing chambers. The individual liquid chambers 106 communicate with the multiple nozzles 104 to discharge liquid, respectively. The fluid restrictors 107 supply the liquid to the individual liquid chambers 106, respectively. The liquid inlets 108 communicate with the fluid restrictors 107, respectively. The adjacent individual liquid chambers 106 are separated by a partition 106A in the nozzle array direction. The liquid is supplied from a common liquid chamber 110 as a common channel of the frame 120 into each of the multiple individual liquid chambers 106 via the liquid inlet 108 and the fluid restrictor 107 through a filter 109 formed in the diaphragm 103.

The piezoelectric actuator 111 is disposed opposite the individual liquid chambers 106 with a deformable vibration portion 130 interposed between the piezoelectric actuator 111 and the individual liquid chamber 106. The vibration portion 130 defines part of a wall of the individual liquid chamber 106 of the diaphragm 103. The piezoelectric actuator 111 includes multiple laminated piezoelectric members 112 bonded onto a base 113. The piezoelectric member 112 is groove-processed by half cut dicing. Pillar-shaped piezoelectric elements (piezoelectric pillars) 112A and piezoelectric elements (support pillars) 112B are disposed at predetermined intervals in a comb shape. The piezoelectric elements 112A are bonded to island-shaped projections 103a in the vibration portions 130 of the diaphragm 103. The piezoelectric elements (support pillars) 112B are bonded to projections 103b of the diaphragm 103.

The piezoelectric member 112 includes piezoelectric layers and internal electrodes alternately laminated one on another. The internal electrodes are led out to end faces to form external electrodes. A flexible printed circuit (FPC) 115 as a flexible wiring board is connected to the external electrodes of the piezoelectric element 112A to apply a drive waveform to the piezoelectric element 112A. The frame 120 defines the common liquid chamber 110 to which liquid is supplied from the head tanks or a liquid cartridge.

In the liquid discharge head 100, for example, when the voltage applied to the piezoelectric element 112A is lowered from a reference potential, the piezoelectric element 112A contracts. As a result, the vibration portion 130 of the diaphragm 103 moves upward, increasing the volume of the individual liquid chamber 106, thus causing liquid to flow into the individual liquid chamber 106. Then, the voltage applied to the piezoelectric element 112A is raised to expand the piezoelectric element 112A in the direction of lamination, and the vibration portion 130 of the diaphragm 103 is deformed toward the nozzle 104 to reduce the volume of the individual liquid chamber 106. Thus, liquid in the individual liquid chamber 106 is pressurized and discharged (jetted) from the nozzle 104.

When the voltage applied to the piezoelectric element 112A is returned to the reference potential, the vibration portion 130 of the diaphragm 103 is returned to the initial position, and the individual liquid chamber 106 expands to generate a negative pressure. Accordingly, liquid is replenished from the common liquid chamber 110 to the individual liquid chamber 106 through the fluid restrictor 107. After the vibration of the meniscus surface of the liquid in the nozzle 104 is attenuated and stabilized, the liquid discharge head 100 shifts to an operation for the next liquid discharge.

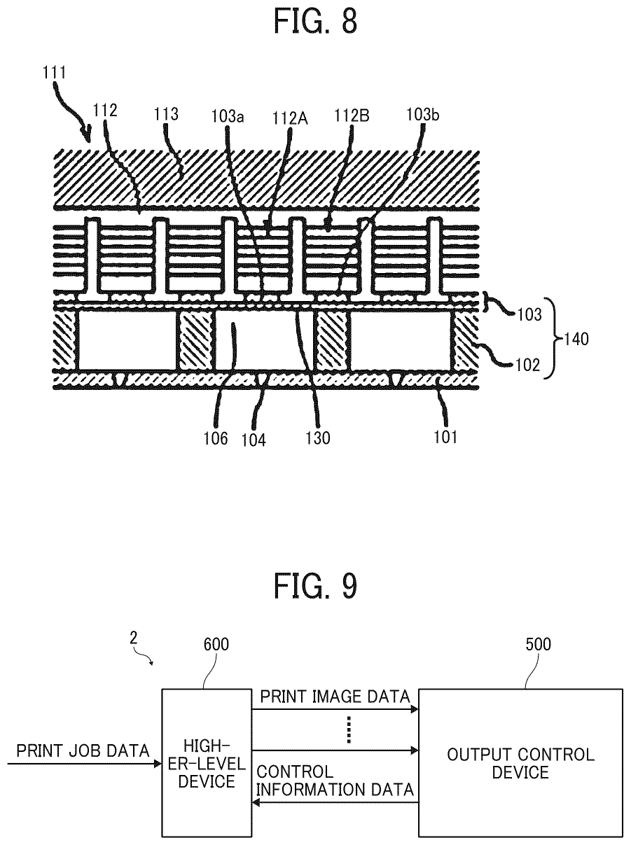

Another liquid discharge head 100 (flow-through type) will be described below with reference to FIGS. 7 and 8. FIG. 7 is a cross-sectional view of the liquid discharge head 100, taken in the direction (i.e., the conveyance direction A of the recording medium) orthogonal to the nozzle array direction (i.e., the width direction B of the recording medium). FIG. 8 is a cross-sectional view of the liquid discharge head 100, taken in the nozzle array direction (i.e., the width direction B of the recording medium).

The liquid discharge head 100 illustrated in FIGS. 7 and 8 is a flow-through head in which the liquid circulates through the individual liquid chamber communicating with the nozzle. The liquid discharge head 100 illustrated in FIG. 7 includes the nozzle plate 101, the channel plate 102, and the diaphragm 103 that are laminated and bonded together, and further includes the piezoelectric actuator 111 to displace the diaphragm 103 and the frame 120 as the common channel substrate.

The nozzle plate 101 has multiple nozzles 104 to discharge a liquid. The channel plate 102 defines the individual liquid chamber 106 communicating with the nozzle 104, the fluid restrictor 107 communicating with the individual liquid chamber 106, and the liquid inlet 108 communicating with the fluid restrictor 107. The channel plate 102 includes multiple plates 41 to 45 laminated and bonded together from the nozzle plate 101 side. The diaphragm 103 is laminated and bonded onto the channel plate 102 including the multiple plates 41 to 45 to construct a channel substrate 140.

The diaphragm 103 has the filter 109 as an opening connecting the liquid inlet 108 and the common liquid chamber 110 defined by the frame 120. The diaphragm 103 defines the wall of the individual liquid chamber 106 of the channel plate 102. In the present embodiment, the diaphragm 103 has, but is not limited to, a two-layer structure including a first layer forming a thin portion and a second layer forming a thick portion in this order from the channel plate 102. A portion of the first layer corresponding to the individual liquid chamber 106 forms the deformable vibration portion 130.

The channel substrate 140, including the channel plate 102 and the diaphragm 103, defines a fluid restrictor 151 extending in an in-plane direction of the channel plate 102 and communicating with the individual liquid chamber 106, a circulation channel 152, and a circulation channel 153 extending in a thickness direction of the channel substrate 140 and communicating with the circulation channel 152. The circulation channel 153 communicates with a circulation common liquid chamber 150, which will be described later.

The frame 120 defines the common liquid chamber 110, to which liquid is supplied from the ink tank or a cartridge, and the circulation common liquid chamber 150. The frame 120 includes a first common chamber substrate 121 that defines a downstream common liquid chamber 110A and the circulation common liquid chamber 150. The frame 120 further includes a second common chamber substrate 122 that defines an upstream common chamber 110B. The second common chamber substrate 122 has a through hole connecting one end of the common liquid chamber 110 in the nozzle array direction and a supply port. The first common chamber substrate 121 and the second common chamber substrate 122 have a through hole connecting the other end (the end opposite to the through hole described above) of the circulation common liquid chamber 150 in the nozzle array direction and a circulation port. In other words, the common liquid chamber 110 and circulation common liquid chamber 150 construct a common circulation channel, and liquid in the individual liquid chambers 106, which respectively communicate with the multiple nozzles 4, is circulated through the common circulation channel.

The piezoelectric actuator 111 is disposed opposite the individual liquid chamber 106 with the diaphragm 103 to deform the vibration portion 130 of the diaphragm 103. As illustrated in FIG. 7, the piezoelectric actuator 111 includes the piezoelectric member 112 bonded onto the base 113. The piezoelectric member 112 is groove-processed by half cut dicing to form a desired number of the pillar-shaped piezoelectric elements 112A and 112B at predetermined intervals in a comb shape in one piezoelectric member 112.

The piezoelectric element 112A of the piezoelectric member 112 is driven by application of drive waveforms, and the piezoelectric element 112B is merely used as a support to which no drive waveform is applied. Alternatively, all of the piezoelectric elements 112A and 112B can be used as the piezoelectric element to be driven by application of drive waveforms. The piezoelectric element 112A is bonded to the projection 103a, which is an island-shaped thick portion on the vibration portion 130 of the diaphragm 103. The piezoelectric element 112B is bonded to the projection 103b, which is a thick portion of the diaphragm 103.

The piezoelectric member 112 includes piezoelectric layers and internal electrodes alternately laminated one on another. The internal electrodes are led out to the end faces to form external electrodes, and the FPC 115 is connected to the external electrodes. In the liquid discharge head 100 having such a configuration, for example, when the voltage applied to the piezoelectric element 112A is lowered from a reference potential, the piezoelectric element 112A contracts. As a result, the vibration portion 130 of the diaphragm 103 moves upward, increasing the volume of the individual liquid chamber 106, thus causing liquid to flow into the individual liquid chamber 106.

Then, the voltage applied to the piezoelectric element 112A is raised to expand the piezoelectric element 112A in the direction of lamination, and the vibration portion 130 of the diaphragm 103 is deformed toward the nozzle 104 to reduce the volume of the individual liquid chamber 106. As a result, the liquid in the individual liquid chamber 106 is pressurized and discharged from the nozzle 104. When the voltage applied to the piezoelectric element 112A is returned to the reference potential, the vibration portion 130 of the diaphragm 103 is returned to the initial position, and the individual liquid chamber 106 expands to generate a negative pressure. Accordingly, liquid is replenished from the common liquid chamber 110 to the individual liquid chamber 106. After the vibration of the meniscus surface of the liquid in the nozzle 104 is attenuated and stabilized, the liquid discharge head 100 shifts to an operation for the next liquid discharge.

The method of driving the liquid discharge head 100 is not limited to the above-described example (pull-push discharge). For example, pull discharge or push discharge may be performed in accordance with the way to apply a drive waveform. The laminated piezoelectric element is used as a unit that applies pressure change to the individual liquid chamber 106, but is not limited thereto. A thin film piezoelectric element can also be used as the unit. Further, the pressure change may be applied to the individual liquid chamber 106 by a thermal resistor disposed in the individual liquid chamber 106, or the pressure change may be generated by an electrostatic force. The thermal resistor generates heat to form a bubble so as to apply the pressure change to the individual liquid chamber 106.

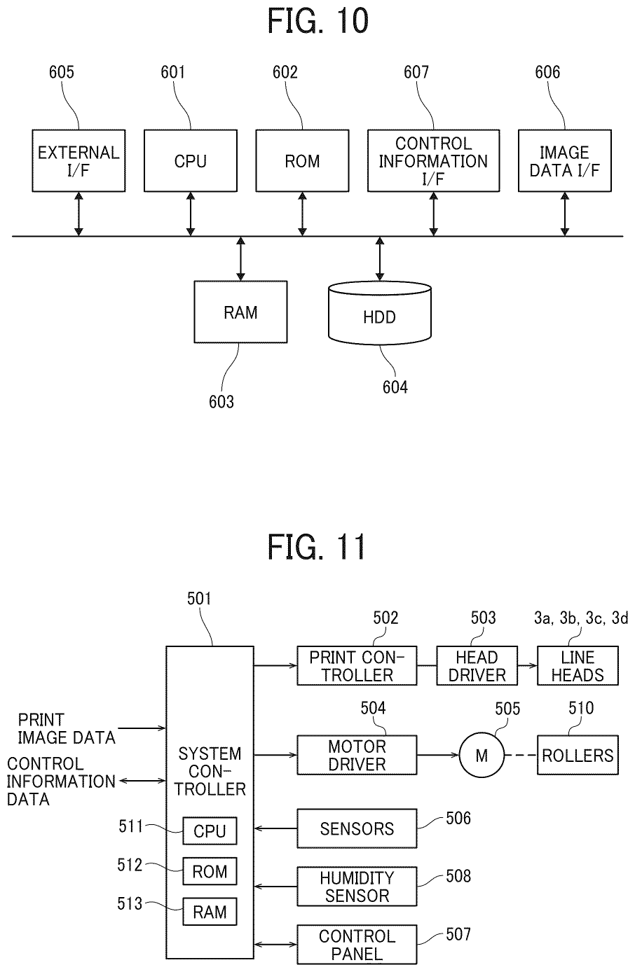

The controller 2 will be described below with reference to FIGS. 9 to 11. FIG. 9 is a block diagram illustrating a schematic configuration of the controller 2. FIG. 10 is a block diagram of a higher-level device included in the controller 2. FIG. 11 is a block diagram of an output control device included in the controller 2.

The controller 2 includes a higher-level device 600 and an output control device 500. The higher-level device 600 receives and processes print job data (including image data) from a host device and transfers the print job data (e.g., print image data) to the output control device 500. The output control device 500 receives the print image data from the higher-level device 600 to control printing. The higher-level device 600 performs raster image processor (RIP) processing, which takes a processing time. The output control device 500 performs print processing.

The higher-level device 600 performs the RIP processing based on the print job data (job data or print data as image data) output from the host device. The higher-level device 600 creates the print image data, which is bitmap data corresponding to the respective colors, based on the print job data.

The higher-level device 600 creates control information data for controlling an image forming operation, which may be referred to as a “printing operation,” based on, for example, the print job data and information of the higher-level device. The control information data includes data relating to printing conditions (e.g., printing mode, printing type, medium feed/ejection information, printing surface order, printing medium size, data size of the print image data, resolution, medium type information, gradation, color information, and information of the number of pages to be printed).

As illustrated in FIG. 10, the higher-level device 600 includes a central processing unit (CPU) 601, a read-only memory (ROM) 602, a random-access memory (RAM) 603, a hard disc drive (HDD) 604, an external interface (I/F) 605, an image data I/F 606, and a control information I/F 607. The CPU 601 receives the print job data from the host device via the external I/F 605, generates bitmap data of colors of Y, M, C, and K, writes the generated bitmap data of the respective colors to the RAM 603, compresses and encodes the bitmap data of the colors, and temporarily stores the bitmap data in the HDD 604. When the printing operation is started, the bitmap data of the colors is decoded and temporarily written in the RAM 603. Then, the bitmap data of the colors is read out and transferred to the output control device 500 via the image data I/F 606 as the print image data of the respective colors. The control information data is transmitted and received between the higher-level device 600 and the output control device 500 via the control information I/F 607 in accordance with the progress of the printing operation.

As illustrated in FIG. 11, the output control device 500 includes a system controller (main controller) 501 including a microcomputer including a CPU 511, a ROM 512, a RAM 513, and an input-output (I/O) unit, an image memory, and a communication interface. The system controller 501 sends the print image data to a print controller 502 to form an image on the continuous medium P based on the print image data and the control information data transferred from the higher-level device 600.

The print controller 502 transfers the print image data received from the system controller 501 as serial data and outputs the transfer clock, latch signals, and control signals for the transfer of the print image data and confirmation of the transfer to a head driver 503. The print controller 502 includes a drive waveform generation unit including a digital-to-analog (D/A) converter to convert pattern data of a common drive waveform stored in an internal ROM from digital to analog, a voltage amplifier, and a current amplifier. The print controller 502 outputs a drive waveform having one or multiple drive pulses to the head driver 503.

The head driver 503 selects the drive pulses forming the drive waveform given from the print controller 502 based on the print image data corresponding to each of the line heads 3a, 3b, 3c, and 3d. The print image data is serially input to the head driver 503, and the drive pulses are applied to the piezoelectric element 112A to discharge liquid. At this time, the head driver 503 selects a part or all of the drive pulses forming the drive waveform or a part or all of waveform elements forming the drive pulse to selectively discharge dots of different sizes, e.g., large droplets, medium droplets, and small droplets.

The system controller 501 controls driving of the rollers 510, such as the unwinder of the feeder 5, the rollers of the conveyor 8, the dryer 6, and the ejector 7, and the rewinder of the ejector 7, with a motor 505 via a motor driver 504. The driving force may not be applied to all the rollers. The system controller 501 receives detection signals from a humidity sensor 508 that detects environmental humidity and sensors 506 including other various sensors. The system controller 501 inputs and outputs various types of information, and exchanges display information with a control panel 507.

The system controller 501 functions as a dummy discharge control unit that performs dummy discharge control to cause the line heads 3a, 3b, 3c, and 3d to discharge liquid from the nozzles 104 as dummy discharge of the liquid with a predetermined dummy discharge pattern into a non-image forming area between image forming areas in the conveyance direction A of the recording medium. The dummy discharge control controls a dummy discharge operation, which may be referred to as a “line flushing operation.” In the dummy discharge operation, liquid is dummy-discharged linearly into the non-image forming area between the image forming areas on the continuous medium P to maintain and recover the state of the nozzles 104. The image forming areas may be referred to as “pages,” and the non-image forming area may be referred to as a “page interval” between the pages.

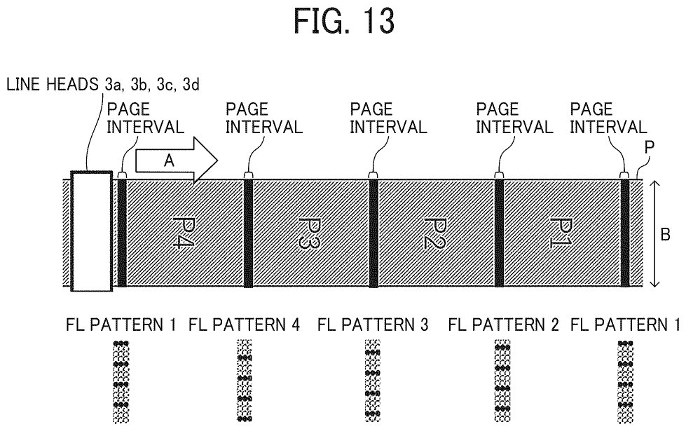

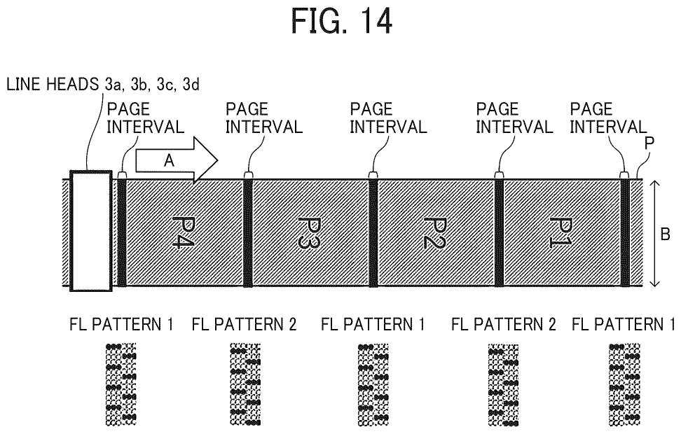

The image forming area (page) means an area where a print image based on input print image data (image data) is formed, and the non-image forming area (page interval) means an area between the image forming areas consecutively arranged in the conveyance direction A of the recording medium. The term “linearly” means that a dot pattern extending in the width direction B of the recording medium is formed. The dot pattern extending in the width direction B includes a pattern in which dots are continuously arranged or intermittently arranged, as illustrated in FIGS. 13 and 14, in the width direction B.

Multiple types of dummy discharge patterns, which are different from each other, used in the line flushing operation are stored in a storage unit (e.g., the ROM 602 or the HDD 604) of the higher-level device 600 or stored in the ROM 512 of the system controller 501. The multiple types of dummy discharge patterns may be referred to as “flushing patterns.” The system controller 501 reads a flushing pattern given from the higher-level device 600 or the corresponding flushing pattern from the ROM 512 according to conditions.

When the liquid in the nozzle is dried and thickened, the liquid may not be appropriately discharged (for example, the speed of the discharged liquid or the amount of the discharged liquid is out of a desired value), and further, the liquid may not be discharged (non-discharge state). To prevent the discharge failure of the nozzles, during consecutive image forming operations (during a print job), liquid is dummy-discharged from the nozzles of the line heads 3a, 3b, 3c, and 3d into every predetermined number of non-image forming areas between pages as the line flushing operation. The predetermined number of non-image forming areas is one, or two or more. In the consecutive image forming operations, images are printed on the consecutive pages.

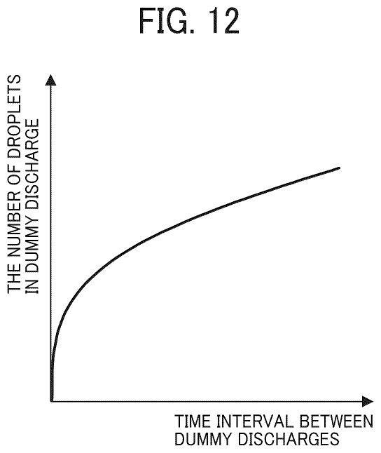

FIG. 12 is a graph illustrating a relationship between a time interval between dummy discharges and an appropriate number of droplets in one dummy discharge for one nozzle. For example, the appropriate number of droplets corresponds to three dots arranged in the conveyance direction A of the recording medium, as illustrated in FIGS. 13 and 14, in one dummy discharge (one page interval) for one nozzle. As illustrated in FIG. 12, as the time from the previous dummy discharge to the dummy discharge to be performed is longer, the liquid in the nozzle becomes drier. Accordingly, the amount of liquid (the number of droplets in the dummy discharge) to be dummy-discharged from the nozzle in the dummy discharge is increased. At this time, if the number of droplets during the dummy discharge is too large, the liquid is dummy-discharged excessively, and thus the liquid is wastefully consumed, increasing the running cost. On the other hand, if the number of droplets during the dummy discharge is too small, the thickened liquid may not be completely discarded. As a result, an appropriate nozzle state may not be maintained, or the nozzle may not be recovered from the discharge failure.

The time interval between dummy discharges is grasped from the print job data to derive the appropriate number of droplets in one dummy discharge, and the appropriate number of droplets is dummy-discharged from the nozzle in the line flushing operation. Thus, the dummy discharge can be controlled. However, in a line flushing operation according to a comparative example, the dummy discharge of the liquid is performed from all the nozzles in one line flushing operation, i.e., in the dummy discharge operation into one page interval (non-image forming area). Accordingly, if the page interval is set to be narrow (if the length of the non-image forming area in the conveyance direction of the recording medium is set to be short), for example, to complete the print job quickly, the length of the page interval may become shorter than the length of the dot pattern linearly formed by the dummy discharge (i.e., a dummy discharge dot pattern) in the conveyance direction of the recording medium, and thus the line flushing operation may not be performed.

In particular, for the purpose of preventing a drying failure of the dummy discharge dot pattern formed with the liquid discharged in the dummy discharge, the line flushing operation may be performed so that the dummy discharge dot pattern includes multiple dots formed at intervals corresponding to one or more dots in the width direction B of the recording medium. In such a case, the length of the dummy discharge dot pattern according to the comparative example, in which the dummy discharge is performed from all nozzles within one page interval (non-image forming area), becomes longer in the conveyance direction of the recording medium. Thus, if the page interval is set to be narrow, the line flushing operation may not be performed. In the drying failure of the dummy discharge dot pattern formed with the liquid discharged in the dummy discharge, the dummy discharge dot pattern is not sufficiently dried and conveyed downstream in the conveyance direction of the recording medium. As a result, the dummy discharge dot pattern not sufficiently dried may contact the conveyance roller, and the liquid may adhere to the conveyance roller. Accordingly, images may be deteriorated.

As described later, the dummy discharge dot pattern formed in the page interval between pages by the line flushing operation is used as an adjustment pattern during the consecutive image forming operations (during the print job). In other words, the dummy discharge dot pattern is read by the in-line sensor of the image inspection device 4, and the liquid discharge timing is adjusted based on the positions of dots in the read dummy discharge dot pattern. The dummy discharge dot pattern used as the adjustment pattern preferably has a dot pattern including multiple dots formed at intervals corresponding to one or more dots in the width direction B of the recording medium. In such a case, the length of the dummy discharge dot pattern in the conveyance direction of the recording medium becomes long. Thus, if the page interval is set to be narrow, the line flushing operation may not be performed.

Accordingly, during the consecutive image forming operations (during the print job), the dummy discharge control is performed using a flushing pattern selected from multiple types of flushing patterns (multiple dummy discharge patterns) different from each other. In other words, the image forming operation and the dummy discharge operation are alternately repeated. The flushing pattern is formed of the liquid discharged into every (each) predetermined number of page intervals (non-image forming areas) between the pages (image forming areas) to form the selected flushing pattern. Each flushing pattern causes the liquid to be discharged from a part of the multiple nozzles of all the line heads 3a, 3b, 3c, and 3d into the corresponding page interval (non-image forming area). When the predetermined number of page intervals is 1, the line flushing operation is completed in a reference number of page intervals (non-image forming areas). Specifically, the dummy discharges are performed while the multiple types of flushing patterns are switched to complete the dummy discharges of all the flushing patterns (dummy discharge patterns).

In the present embodiment, N types of flushing patterns are prepared (N is a natural number of 2 or more), and the line flushing operation is performed while switching the flushing patterns in each page interval between pages. The flushing pattern may be referred to as the “FL pattern.” The flushing patterns are switched in the order of FL pattern 1 to FL pattern N, return to FL pattern 1 after FL pattern N, and repeat the switching in the order of FL pattern 1 to FL pattern N (i.e., an example of a predetermined order). The number of the dummy discharge patterns (i.e., N) and the predetermined order can be set in advance, for example, by a user.

FIG. 13 is a diagram illustrating the line flushing operation. In FIG. 13, during the consecutive image forming operations (during the print job), the line flushing operation is performed by sequentially switching the flushing patterns from FL pattern 1 to FL pattern 4 in each page interval and repeating the flushing patterns in this order. In FIG. 13, the number of FL patterns (i.e., the reference number N) is 4, and the predetermined number of page intervals (i.e., a predetermined number M) is 1. In other words, the line flushing operation is performed while repeatedly switching the flushing patterns in the order of FL pattern 1 to FL pattern 4 in subsequent four page intervals following the four page intervals (i.e., the reference number=4).

Each of the four types of FL patterns illustrated in FIG. 13 causes liquid to be dummy-discharged from only a part of the nozzles of all the line heads 3a, 3b, 3c, and 3d. Focusing on each of the nozzles, the dummy discharge is not performed in some of the page intervals. Specifically, the dummy discharge from any nozzle is performed by one of the four types of FL patterns illustrated in FIG. 13. When the predetermined number M=1 and the line flushing operation of the four types of FL patterns is finished (when the line flushing operation up to the fourth page interval is finished), the dummy discharge of all the nozzles is completed.

More specifically, in FIG. 13, in each nozzle array of the line heads 3a, 3b, 3c, and 3d, the dummy discharge from the {4 (n−1)+1}th nozzles (n is a natural number) is performed by FL pattern 1, the dummy discharge from the {4 (n−1)+2}th nozzles is performed by FL pattern 2, the dummy discharge from the {4 (n−1)+3}th nozzles is performed by FL pattern 3, and the dummy discharge from the {4 (n−1)+4}th nozzles is performed by FL pattern 4. Accordingly, when the number of types of FL patterns switched in the predetermined order is N (i.e., a reference number N), the dummy discharge control is performed so that one dummy discharge from each nozzle is performed every N×M page intervals. In FIG. 13, since the reference number N=4 and the predetermined number M=1, one dummy discharge is performed every four page intervals (N×M=4×1=4) from each nozzle. For example, when the reference number N=4 and the predetermined number M=2, one dummy discharge is performed every eight page intervals (N×M=4×2=8) from each nozzle. In this case, the dummy discharge is not performed in half of the eight page intervals.

In FIG. 13, in the line flushing operation in each page interval, the dummy discharge is performed from 1/N nozzles of all the nozzles. Focusing on each nozzle, one dummy discharge operation is performed every N page intervals (when the predetermined number M=1). The number of droplets to be dummy-discharged from each nozzle in one dummy discharge operation may be one, or two or more (three dots in FIG. 13).

FIG. 14 is a diagram illustrating another line flushing operation. In FIG. 14, during the consecutive image forming operations (during the print job), the line flushing operation is performed by sequentially switching the flushing patterns from FL pattern 1 to FL pattern 2 in each page interval and repeating the flushing patterns in this order. In other words, the number of FL patterns (i.e., the reference number N) is 2, and the predetermined number of page intervals (i.e., the predetermined number M) is 1. The line flushing operation is performed while repeatedly switching the flushing patterns in the order of FL pattern 1 to FL pattern 2 in subsequent two page intervals following the two page intervals (i.e., the reference number=2).

Each of the two types of FL patterns illustrated in FIG. 14 causes liquid to be dummy-discharged from only a part of the nozzles of all the line heads 3a, 3b, 3c, and 3d. Focusing on each of the nozzles, the dummy discharge is not performed in some of the page intervals. Specifically, the dummy discharge from any nozzle is performed by one of the two types of FL patterns illustrated in FIG. 14. When the predetermined number M=1 and the line flushing operation of the two types of FL patterns is finished (when the line flushing operation up to the second page interval is finished), the dummy discharge of all the nozzles is completed.

More specifically, in FIG. 14, in each nozzle array of the line heads 3a, 3b, 3c, and 3d, the dummy discharge from the odd-numbered nozzles is performed by FL pattern 1, and the dummy discharge from the even-numbered nozzles is performed by FL pattern 2. Accordingly, the dummy discharge control is performed so that one dummy discharge from each nozzle is performed every N×M page intervals. In FIG. 14, since the reference number N=2 and the predetermined number M=1, one dummy discharge is performed every two page intervals (N×M=2×1=2) from each nozzle. Accordingly, in FIG. 14, the frequency of the dummy discharge per nozzle is higher than the frequency in FIG. 13.

Each of the two types of FL patterns as illustrated in FIG. 14 has multiple dots formed of liquid dummy-discharged into the page interval. The positions of dots and adjacent dots, which are adjacent to the dots in the width direction B of the recording medium, are shifted from each other in the conveyance direction A of the recording medium. Specifically, in FL pattern 1, the dots formed by the dummy discharge from the {4 (n−1)+1}th nozzle and the dots formed by the dummy discharge from the {4 (n−1)+3}th nozzle are shifted from each other in the conveyance direction A of the recording medium, and in FL pattern 2, the dots formed by the dummy discharge from the {4 (n−1)+2}th nozzle and the dots formed by the dummy discharge from the {4 (n−1)+4}th nozzle are shifted from each other in the conveyance direction A of the recording medium. Accordingly, in FIG. 14, the length of one FL pattern in the conveyance direction A of the recording medium is longer than (twice as long as) the length of the FL pattern illustrated in FIG. 13.

In each of the two types of FL patterns, as illustrated in FIG. 14, having multiple dots formed of liquid dummy-discharged into the page interval, the positions of dots and adjacent dots, which are adjacent to the dots in the width direction B of the recording medium, may be arranged at the same position in the conveyance direction A of the recording medium. In such an arrangement, the length of the FL pattern can be the same as that in FIG. 13.

In the present embodiment, the length of the dot pattern, linearly formed by dummy discharge, in the conveyance direction of the recording medium (i.e., the dummy discharge dot pattern) can be shorter than in the comparative example using the FL pattern (dummy discharge pattern) in which dummy discharge is performed from all nozzles within one page interval (non-image forming area). Accordingly, even if the length of page interval in the conveyance direction of the recording medium is set to be short, the line flushing operation (dummy discharge control) can be performed.

When the predetermined number of page intervals is 1, the line flushing operation is completed in the reference number of page intervals (non-image forming areas). For example, the reference number is 4 for the four types of flushing patterns as illustrated in FIG. 13, and the reference number is 2 for the two types of flushing patterns as illustrated in FIG. 14. Specifically, the dummy discharges are performed while the multiple types of flushing patterns are switched to complete the dummy discharges of all the flushing patterns (dummy discharge patterns). Accordingly, although the dummy discharge is performed only from a part of the nozzles in one page interval, the dummy discharge of all the flushing patterns (dummy discharge from all the nozzles) is completed by performing the dummy discharges in the reference number of page intervals. Thus, the nozzle state of the liquid discharge head 100 is appropriately maintained and recovered.

As described below, the in-line sensor of the image inspection device 4 reads the dummy discharge dot pattern formed in the page interval (non-image forming area) between pages during the consecutive image forming operations, and the defective nozzle detection control is performed to detect the presence or absence of a defective nozzle (including a non-discharge nozzle), in which a discharge failure occurs, based on the dummy discharge dot pattern read by the in-line sensor.

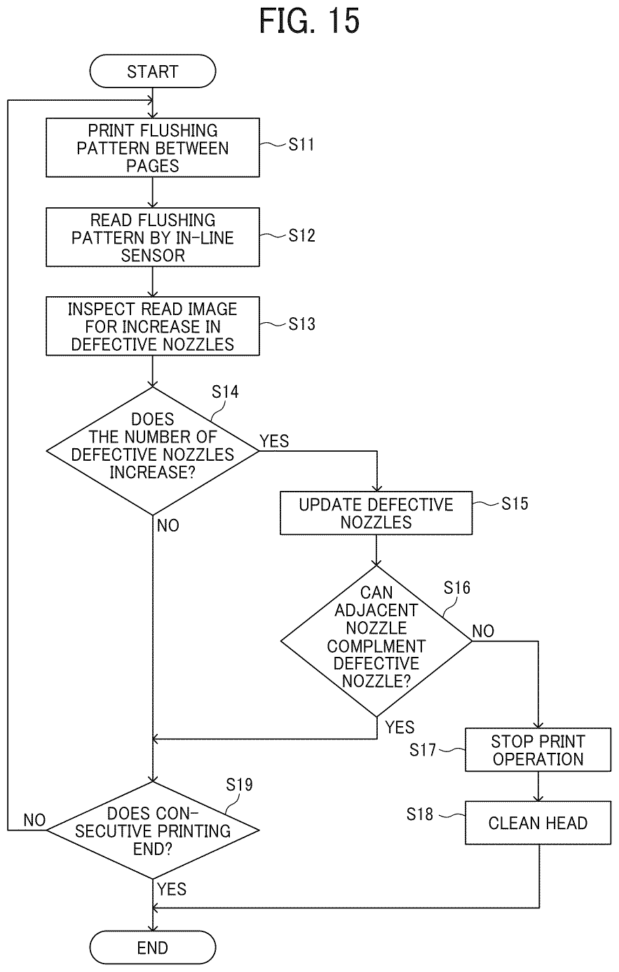

FIG. 15 is a flowchart of the defective nozzle detection control performed during the consecutive image forming operations. When starting the print job to start the consecutive image forming operations, the controller 2 controls the line heads 3a, 3b, 3c, and 3d by the head discharge controller 2c to form a print image in an image forming area on the continuous medium P. In step S11, the controller 2 performs the line flushing operation in the page intervals (non-image forming areas) while sequentially switching the N types of FL patterns. The portion of the continuous medium P on which dot pattern formed of the liquid dummy-discharged (dummy discharge dot pattern) is cut out later.

In step S12, the controller 2 controls the image inspection device 4 by the image inspection device controller 2d to read the dummy discharge dot pattern formed in the page interval between pages by the in-line sensor of the image inspection device 4. The image inspection device 4 functions as a defective nozzle detector to detect defective nozzles based on the number of missing dots and dot misalignment in the dummy discharge dot pattern read by the in-line sensor. In step S13, the controller 2 controls the image inspection device 4 to inspect the dummy discharge dot pattern to determine whether the number of defective nozzles detected has increased from the number of defective nozzles during the previous defective nozzle detection control.

In step S14, when the controller 2 determines, with the image inspection device 4, that the number of defective nozzles does not increase (No in step S14), in step S19, the controller 2 continues the consecutive image forming operations (continuous printing) when the consecutive image forming operations are not finished (No in step S19). When the consecutive image forming operations are finished (Yes in step S19), the process of the consecutive image forming operations ends. In step S14, when the controller 2 determines, with the image inspection device 4, that the number of defective nozzles increases (Yes in S14), the image inspection device 4 outputs information of the defective nozzles to the controller 2. Accordingly, the controller 2 performs, for example, a process of notifying the user that a discharge failure of the nozzle occurs.

The controller 2 executes, for example, non-discharge complementation control based on the information of the defective nozzle. In step S15, when executing the non-discharge complementation control, the controller 2 stores a nozzle number of the defective nozzle, which is newly detected, in a memory based on the information of the defective nozzles and updates the information of the defective nozzles.

In step S16, the controller 2 determines whether the newly detected defective nozzle can be complemented using the nozzles surrounding the defective nozzle based on the nozzle number of the defective nozzle previously detected by the defective nozzle detection control and the nozzle number of the newly detected defective nozzle. In step S16, when the controller 2 determines that the defective nozzle is not complemented (No in step S16), in step S17, the controller 2 stops the consecutive image forming operations. In step S18, the controller 2 executes a head cleaning to clean the liquid discharge head 100 to recover the nozzle from the discharge failure.

In step S16, when the controller 2 determines that the defective nozzle can be complemented using the nozzles surrounding the defective nozzle (Yes in step S16), the controller 2 executes an image correction process using the nozzles surrounding the defective nozzle, and the process goes to step S19. In step S19, the controller 2 continues the consecutive image forming operations, or the process of the consecutive image forming operations ends.

In the present embodiment, the dot pattern (dummy discharge dot pattern) formed of the liquid, which is dummy-discharged, is used as a pattern to detect the presence or absence of a defective nozzle. As a result, the consumption of liquid can be reduced compared to the case where a pattern for detecting the presence or absence of a defective nozzle is formed separately from the line flushing operation.

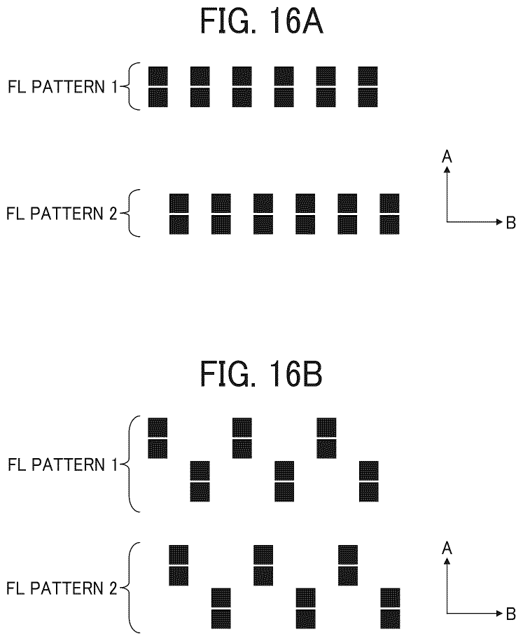

A description is given below of a flushing pattern (FL pattern) suitable for the defective nozzle detection control performed during the consecutive image forming operations. FIGS. 16A and 16B are diagrams each illustrating FL patterns suitable for the defective nozzle detection control. In FIGS. 16A and 16B, the FL patterns are formed of black liquid (black ink) dummy-discharged from the nozzle of the line head 3a of black (K), which can be used in, for example, a monochrome inkjet printer. In FIGS. 16A and 16B, the top-bottom direction is the conveyance direction A of the recording medium, and the left-right direction is the width direction B of the recording medium.

In both FIGS. 16A and 16B, the two types of FL patterns are switched and alternately used during the consecutive image forming operations, and the dot patterns (the dummy discharge dot patterns) formed of the liquid, which is dummy-discharged according to the respective FL patterns 1 and 2, are formed in the page intervals between pages. In the dummy discharge dot patterns formed as illustrated in FIGS. 16A and 16B, the dot interval in the width direction B of the recording medium is one dot or more. Specifically, in FIG. 16A, both the FL patterns 1 and 2 are patterns in which the dot interval in the width direction B of the recording medium is one dot, and in FIG. 16B, both the FL patterns 1 and 2 are patterns in which the dot interval in the width direction B of the recording medium is three dots.

If droplets (dots) of the liquid dummy-discharged contact and merge with each other, the liquid is not quickly dried on the continuous medium P. As a result, the liquid, which is not sufficiently dried, may contacts and adheres to the conveyance roller on the downstream side in the conveyance direction of the recording medium, causing deterioration of an image. In addition, if droplets (dots) of the liquid dummy-discharged contact and merge with each other, the image inspection device 4 may not grasp a relationship between the dot of the liquid dummy-discharged and the nozzle corresponding the dot from the image read by the in-line sensor of the image inspection device 4.

With the FL patterns illustrated in FIGS. 16A and 16B, a droplet of the liquid dummy-discharged does not land at a position next to the position at which another droplet lands in the width direction B of the recording medium. As a result, droplets of the liquid dummy-discharged do not contact and merge with each other. Accordingly, the liquid which is dummy-discharged by the line flushing operation is quickly dried on the continuous medium P to prevent the deterioration of an image. In addition, the image inspection device 4 can easily grasp the relationship between the dot of the liquid dummy-discharged and the nozzle corresponding to the dot from the image read by the in-line sensor of the image inspection device 4 to more appropriately perform the defective nozzle detection control.

The dot interval in the width direction B of the recording medium (the number of dots to be spaced) can be set as appropriate. At this time, when the dot interval in the width direction B of the recording medium is widened, and the dummy discharge from the nozzles corresponding to the positions within the dot interval is performed in another FL pattern, the number of types of FL patterns is increased. In this case, the frequency of the dummy discharge for each nozzle is lowered. Accordingly, the dot interval in the width direction B of the recording medium is widened in consideration of the number of types of FL patterns to be switched based on the frequency of the dummy discharge for maintaining and recovering the nozzle state.

When the dot interval in the width direction B of the recording medium is widened, as illustrated in FIG. 16B, each of FL patterns 1 and 2 may have first dots and second dots formed of the liquid which is dummy-discharged. In the pattern, the second dots are positioned adjacent to the first dots in the width direction B and shifted from the first dots in the conveyance direction A of the recording medium. The first dots are arranged with the dot interval (three dots in FIG. 16B) in the width direction B, and the second dots are arranged with the dot interval (three dots in FIG. 16B) in the width direction B. In this case, the dot interval in the width direction B of the recording medium can be widened from one dot illustrated in FIG. 16A to three dots illustrated in FIG. 16B while preventing an increase in the number of types of FL patterns (while preventing a decrease in the frequency of the dummy discharge for each nozzle).

However, in this case, the length of the dummy discharge dot pattern linearly formed by the line flushing operation becomes long in the conveyance direction of the recording medium (i.e., the thickness of the line increases). Accordingly, if the length of the page interval in the conveyance direction of the recording medium is narrow, the line flushing operation (dummy discharge control) may not be performed. For this reason, the dummy discharge dot pattern is selected in consideration of the length of the page interval in the conveyance direction of the recording medium.

Further, the dot interval in the width direction B of the recording medium is preferably widened in consideration of the ease of merging of droplets of the liquid dummy-discharged. For example, the volume of droplets of the liquid to be dummy-discharged may vary depending on the print mode. The size of the dot on the continuous medium P increases as the volume of droplets of the liquid to be dummy-discharged increases, and thus droplets of the liquid dummy-discharged are likely to merge with each other. For this reason, the dummy discharge dot pattern is preferably selected in consideration of this point. For example, the size of the dot on the continuous medium P changes depending on the type of the continuous medium P. For this reason, the dummy discharge dot pattern is preferably selected in consideration of this point.

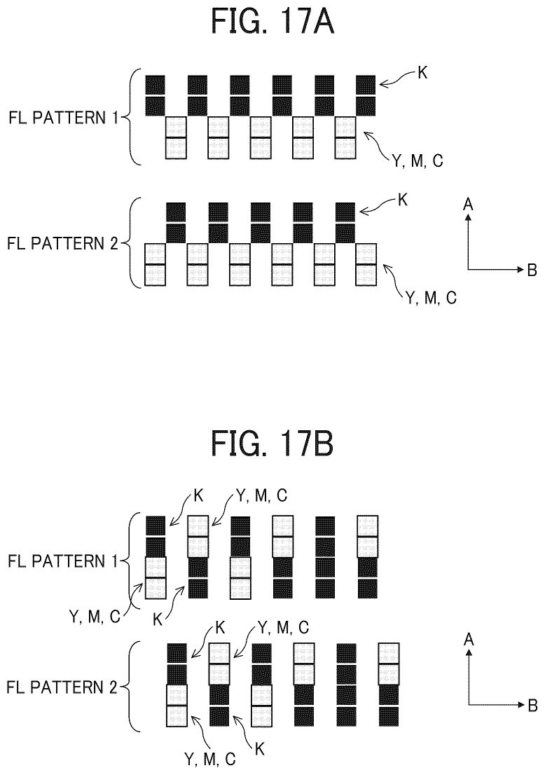

FIGS. 17A and 17B are diagrams each illustrating other FL patterns suitable for the defective nozzle detection control. For example, the line head 3a for black (K) dummy-discharges black liquid (K ink) from the nozzles to form dots of the black liquid, and the line heads 3b, 3c, and 3d for colors of yellow (Y), magenta (M), and cyan (C), respectively, dummy-discharges color liquids (Y ink, M ink, and C ink) from the nozzles to form dots of the color liquids. In each of FIGS. 17A and 17B, the FL pattern includes the dots of the black liquid and the dots of the color liquids. The color liquids, i.e., the Y ink, the M ink, and the C ink are superimposed one on another at the same position to form mixed color dots. In FIGS. 17A and 17B, the top-bottom direction is the conveyance direction A of the recording medium, and the left-right direction is the width direction B of the recording medium.

In both FIGS. 17A and 17B, the two types of FL patterns are switched and alternately used during the consecutive image forming operations, and the dot patterns (the dummy discharge dot patterns) formed of the liquid, which is dummy-discharged according to the respective FL patterns 1 and 2, are formed in the page intervals between pages. In the dummy discharge dot patterns formed as illustrated in FIGS. 17A and 17B, the dot interval between dots formed of the dummy-discharged liquid of the same color in the width direction B of the recording medium is one dot or more. Such a dummy discharge dot pattern can prevent droplets of the same color liquid dummy-discharged from contacting and merging with each other. Accordingly, the relationship between the dot of the liquid dummy-discharged and the nozzle corresponding to the dot can be easily grasped.

The dot interval in the width direction B of the recording medium (the number of dots) can be appropriately set in consideration of various points as described above.

As illustrated in FIG. 17A, each of FL patterns 1 and 2 may have first dots of a first color and second dots of a second color different from the first color, which are formed of the liquid dummy-discharged. In the pattern, the second dots of the second color are shifted from the first dots of the first color in the conveyance direction A of the recording medium. As illustrated in FIG. 17B, in each of FL patterns 1 and 2, the second dots of the second color, which are formed of liquid (e.g., the Y ink, the M ink, and the C ink) dummy-discharged, may be positioned between the first dots of the first color, which are formed of another liquid (e.g., the K ink) dummy-discharged, in the width direction B of the recording medium. With such FL patterns, even if the dot interval in the width direction B of the recording medium for the liquid of the same color to be dummy-discharged is widened, the length of the dummy discharge dot pattern, which is linearly formed, in the conveyance direction of the recording medium can be prevented from being increased.

Even if the dot interval in the width direction B of the recording medium between dots (the first dots and the second dots) formed of the liquids of different colors is narrow, the relationship between the dot of the liquid dummy-discharged and the nozzle corresponding to the dot can be grasped. This is because, even if dots (droplets) of liquids of different colors contact and merge with each other, the nozzle corresponding to the dot can be specified by the difference in color.

In FIGS. 17A and 17B, the dots of the color liquids dummy-discharged are superimposed one on another at the same position to form the mixed color dots of three colors of the Y ink, the M ink, and the C ink. Accordingly, the image inspection device 4 can specify which color ink to be dummy-discharged from the nozzle has a discharge failure based on a change in color values or lightness of the mixed color dots in the image read by the in-line sensor of the image inspection device 4. For example, when gray dots in which three colors of the Y ink, the Mink, and the C ink are mixed are formed, if the C ink is not discharged from the nozzle (i.e., missing dot), red dots in which two colors of the Y ink and the M ink are mixed are formed instead of the gray dots.

However, when color inks are mixed with the K ink (i.e., black) in dots, even if a discharge failure occurs in any of the nozzles of the mixed colors, since the change in color values or lightness of the mixed color dots is small, the image inspection device 4 may not specify which color ink to be dummy-discharged from the nozzle has a discharge failure. Accordingly, the mixed color dots preferably do not include black. In other words, preferably, the first color and the second color are colors other than black.

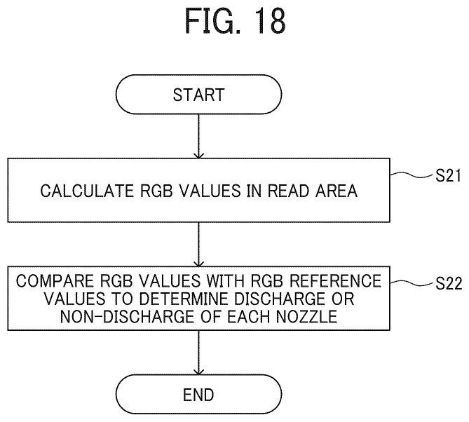

FIG. 18 is a flowchart of a specification process of defective nozzle in the image inspection device 4 when the defective nozzle detection control is performed using the FL patterns of FIGS. 17A and 17B.

As described above, in step S12, the controller 2 controls the image inspection device 4 by the image inspection device controller 2d to read the dummy discharge dot pattern formed in the page interval between pages by the in-line sensor of the image inspection device 4. When the FL patterns of FIGS. 17A and 17B are used, in step S21, the image inspection device 4 calculates RGB values (i.e., color values) of the image read by the in-line sensor as illustrated in FIG. 18. In step S22, the image inspection device 4 compares the calculated RGB values with RGB reference values and determines which color ink to be dummy-discharged from the nozzle has a discharge failure based on the calculated RGB values of the dot indicating the abnormal values. After the defective nozzle is specified in this manner, the process proceeds as in FIG. 15 described above.

Preferably, three-dimensional values such as the RGB values (i.e., color values) are calculated for comparison with reference values to determine which color nozzle has a discharge failure. Alternatively, a one-dimensional value such as a gray scale (lightness) may be used to determine which color nozzle has a discharge failure.

In FIGS. 17A and 17B, the dots of the color liquids dummy-discharged includes the three colors of the Y ink, the M ink, and the C ink mixed with each other. Alternatively, the dots may include one color (any one of the Y ink, the C ink, and the M ink), or may include two colors, preferably, two colors other than black (the K ink), mixed with each other (the C ink+the M ink, the M ink+the Y ink, or the Y ink+the C ink). In particular, when the number of colors to be mixed is increased, the amount of liquid per dot increases, which may cause deterioration of an image due to drying failure. Accordingly, the number of colors to be mixed is set as appropriate in consideration of this point.

In the present embodiment, multiple sets of multiple types of FL patterns to be switched may be prepared, and the controller 2 as a change unit may change the set based on a predetermined change condition. The predetermined change condition described above may be, for example, a condition for changing the set of the FL patterns based on a user instruction, or may be a condition for changing the FL patterns based on a processing result of the image inspection device 4. The set of the multiple types of FL patterns may be changed by the controller 2 before the start of the consecutive image forming operation or during the consecutive image forming operation.

According to this configuration, for example, the multiple sets of FL patterns, each of which is appropriate for a certain degree of spread of dots, are stored in advance. When the predetermined change condition indicating, for example, the deterioration of an image is satisfied, the set of FL patterns is changed to prevent the deterioration of an image. In the defective nozzle detection control described above, when a predetermined change condition indicating that the defective nozzle is not appropriately detected is satisfied, the set of FL patterns is changed to appropriately detect the defective nozzle.

In the present embodiment, the continuous medium P is used as a recording medium, which is a discharge target onto which liquid is discharged, but a recording medium divided into individual sheets may be used as the discharge target.

In the present embodiment, the “liquid discharge head” refers to a functional component to discharge or jet liquid from the discharge orifice (nozzle). Liquid to be discharged through the nozzle of the liquid discharge head is not limited to a particular liquid as long as the liquid has a viscosity or surface tension to be discharged from the liquid discharge head. However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication. Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

In the present embodiment, the multiple liquid discharge heads are arranged in the sheet width direction, which is orthogonal to the conveyance direction, to form a long liquid discharge head (line head), and the liquid discharge head does not move with respect to an apparatus body of the liquid discharge apparatus. However, the liquid discharge head may be combined with other components to construct a “liquid discharge unit,” and the liquid discharge unit may print while moving with respect to the apparatus body.

The “liquid discharge unit” refers to a liquid discharge head integrated with functional components or mechanisms, i.e., an assembly of components related to liquid discharge. For example, the “liquid discharge unit” may include a combination of the liquid discharge head with at least one of a supply-circulation mechanism, a carriage, a maintenance mechanism, or a main-scanning moving mechanism. The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head, the functional components, and the mechanisms may be detachably attached to each other.

Examples of the liquid discharge unit further include the liquid discharge head integrated with the supply-circulation mechanism. In this case, the liquid discharge head and the supply-circulation mechanism may be connected to each other with a tube. Furthermore, a filter unit may be disposed between the supply-circulation mechanism and the liquid discharge head of the liquid discharge unit. In another example, the liquid discharge unit may be an integrated unit in which a liquid discharge head is integrated with a carriage. As yet another example, the liquid discharge unit is a unit in which the liquid discharge head and the main-scanning moving mechanism are combined into a single unit. The liquid discharge head is movably held by a guide that is a part of the main-scanning moving mechanism. In another example, a cap that forms a part of the maintenance mechanism is fixed to the carriage mounting the liquid discharge head so that the liquid discharge head, the carriage, and the maintenance mechanism are integrated as a single unit to form the liquid discharge unit. Further, in still another example, the liquid discharge unit includes a tube connected to the liquid discharge head mounting the supply-circulation mechanism or a channel component so that the liquid discharge head and the supply mechanism are integrated as a single unit. Through the tube, the liquid in a liquid storage source is supplied to the liquid discharge head. The main-scanning moving mechanism may be a guide only. The supply mechanism may be a tube(s) only or a loading device only.

The “liquid discharge apparatus” includes the liquid discharge head or the liquid discharge unit (e.g., the liquid discharge device) and drives the liquid discharge head to discharge liquid. The liquid discharge apparatus may be, for example, any apparatus that can discharge liquid to a medium onto which liquid can adhere or any apparatus to discharge liquid toward gas or into a different liquid. The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging liquid, or a three-dimensional fabrication apparatus to discharge fabrication liquid to a powder layer in which powder material is formed in layers so as to form a three-dimensional object. The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The term “medium onto which liquid can adhere” represents a medium onto which liquid is at least temporarily adhered, a medium onto which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified. Examples of materials for the “medium onto which liquid can adhere” include any materials to which liquid can adhere even temporarily, such as paper, thread, fiber, fabric, leather, metal, plastic, glass, wood, and ceramic. The shape of the “medium onto which liquid can adhere” is not limited to a sheet shape such as the continuous medium P, and may be any shape as long as liquid can adhere to the medium. For example, the “medium onto which liquid can adhere” may be used for film products, cloth products such as clothing, building materials such as wallpaper and flooring, and leather products.

Further, the term “liquid” is not limited to a particular liquid and includes any liquid having a viscosity or a surface tension that can be discharged from the head. However, preferably, the viscosity of the liquid is not greater than 30 millipascal-second (mPa s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The printer 1 described above is the “liquid discharge apparatus” to move the liquid discharge head and the medium onto which liquid can adhere relative to each other. Examples of the liquid discharge apparatus that moves the liquid discharge head and the medium onto which liquid can adhere relative to each other include a serial head apparatus that moves the liquid discharge head or a line head apparatus that does not move the liquid discharge head. The term “liquid discharge apparatus” is not limited to an apparatus to move the liquid discharge head and the medium onto which liquid can adhere relative to each other.

Examples of the “liquid discharge apparatus” further include a treatment liquid coating apparatus to discharge a treatment liquid to a sheet to coat a surface of the sheet with the treatment liquid, for reforming the surface of the sheet. Examples of the “liquid discharge apparatus” further include an injection granulation apparatus in which a composition liquid including raw materials dispersed in a solution is injected through a nozzle to granulate fine particles of the raw materials. In the present specification, the terms “image formation,” “recording,” “printing,” “image printing,” and “fabricating” used herein may be used synonymously with each other.

The embodiments described above are just examples, and the various aspects of the present disclosure attain respective effects as follows.

### Aspect 1

A liquid discharge apparatus (e.g., the inkjet printer 1) includes an image forming device (e.g., the image forming device 3) and a dummy discharge control unit (e.g., the head discharge controller 2c). The image forming device discharge a liquid from multiple nozzles (e.g., the multiple nozzles 104) on the liquid discharge heads 100 of the line heads 3a, 3b, 3c, and 3d within image forming areas (e.g., pages) on a recording medium (e.g., the continuous medium P) conveyed by the conveyor 8 based on input image data (e.g., the print data) to form an image. The dummy discharge control unit performs a dummy discharge control to cause the liquid to be dummy-discharged from the multiple nozzles onto a non-image forming area (e.g., a page interval) between the image forming areas in the conveyance direction A of the recording medium with a predetermine dummy discharge pattern (e.g., the FL pattern). The dummy discharge control unit performs the dummy discharge control while switching a selected dummy discharge pattern (e.g., one of FL pattens 1 to 4) so as to perform a dummy discharge with the selected dummy discharge pattern selected from multiple types of dummy discharge patterns different from each other (e.g., the FL pattens 1 to 4), each of which cause the liquid to be dummy-discharged from a part of the multiple nozzles in every predetermined number of non-discharge areas (e.g., each of the non-discharge areas), and complete the dummy discharge with all the multiple types of dummy discharge patterns (e.g., all the FL pattens 1 to 4) up to a reference number, which is greater than the predetermined number, of non-discharge areas, during consecutive image forming operations.

In other words, a liquid discharge apparatus includes a conveyor, a liquid discharge device, and circuitry. The conveyor conveys a recording medium in a conveyance direction. The liquid discharge device includes a liquid discharge head having multiple nozzles. The liquid discharge head discharges a liquid, in a discharge direction orthogonal to the conveyance direction, from the multiple nozzles onto the recording medium conveyed in the conveyance direction. The circuitry causes the liquid discharge head to: discharge the liquid into each of image forming areas on the recording medium, to form an image in each of the image forming areas to perform an image forming operation; and discharge the liquid into every predetermined number of non-image forming areas between the image forming areas in the conveyance direction, to form multiple dummy discharge patterns in each of the non-image forming areas to perform a dummy discharge operation. Further, the circuitry selects one of the multiple dummy discharge patterns to discharge the liquid from a part of the multiple nozzles to one of the non-image forming areas to perform a part of the dummy discharge operation; switches the multiple dummy discharge patterns: from the one of the multiple dummy discharge patterns; to another of the multiple dummy discharge patterns, to discharge the liquid from another part of the multiple nozzles to perform another part of the dummy discharge operation; and alternately repeats the image forming operation and the dummy discharge operation to discharge the liquid from all the multiple nozzles with all the multiple dummy discharge patterns to complete one cycle of the dummy discharge operation.

In addition, the circuitry alternately repeats the image forming operation and the dummy discharge operation a number of times equal to a number of the multiple dummy discharge patterns to discharge the liquid from all the multiple nozzles with all the multiple dummy discharge patterns to complete one cycle of the dummy discharge operation.

In a comparative example, a dummy discharge pattern that causes liquid to be dummy-discharged from all nozzles in one non-image forming area is used. In other words, a dummy discharge is performed in one non-image forming area. Accordingly, when the interval between the image forming areas in the conveyance direction of the recording medium is set to be narrow to quickly complete the consecutive image forming operations, the length of the non-image forming area in the conveyance direction of the recording medium (may be referred to simply as “length” in the following description), in which the dummy discharge is performed, becomes narrow, and the dummy discharge pattern according to the comparative example may not be used in the narrow non-image forming area. In particular, for preventing a drying failure of the liquid dummy-discharged, a dummy discharge pattern may be used in which a dot interval of the liquid dummy-discharged onto a non-image forming area is set to be one dot or more in a width direction of the recording medium orthogonal to the conveyance direction of the recording medium. In this case, with the dummy discharge pattern in which the dummy discharge is performed from all the nozzles in one non-image forming area, since the length of the non-image forming area for the dummy discharge becomes long, the dummy discharge pattern may not be used when the interval between the image forming areas in the conveyance direction of the recording medium is set to be narrow, and thus the dummy discharge control is not performed. For example, with the drying failure of liquid dummy-discharged, the liquid dummy-discharged is not sufficiently dried and is conveyed downstream in the conveyance direction of the recording medium. As a result, the liquid not sufficiently dried may contact a conveyance member (e.g., the conveyance roller) on the downstream side in the conveyance direction, and the liquid may adhere to the conveyance member. Accordingly, images may be deteriorated.

In the present aspect, during the consecutive image forming operations, the dummy discharge control is performed using a selected dummy discharge pattern selected from multiple types of dummy discharge patterns different from each other. The dummy discharge pattern is formed of the liquid discharged into each (every) predetermined number of non-image forming areas to form the selected dummy discharge pattern. Each dummy discharge pattern causes the liquid to be discharged from a part of the multiple nozzles into the corresponding non-image forming area. According to this configuration, as compared with the dummy discharge pattern in which the dummy discharge is performed from all the nozzles in one non-image forming area according to the comparative example, the length of the non-image forming area can be set to be short. Accordingly, even when the interval between the image forming areas in the conveyance direction of the recording medium is set to be narrow, the dummy discharge control can be performed. In the present aspect, the dummy discharge control is performed while switching the selected dummy discharge pattern so that the dummy discharge of all of the multiple types of dummy discharge patterns is completed up to the non-image forming area of the reference number larger than the predetermined number. Accordingly, although the dummy discharge is performed only from a part of the nozzles in one non-image forming area, all the dummy discharges from all the nozzles are completed by performing the dummy discharges in the reference number of non-image forming areas.

### Aspect 2

In the liquid discharge apparatus according to Aspect 1, the dummy discharge control unit performs the dummy discharge control while switching the selected dummy discharge pattern in a predetermined order up to the reference number of non-image forming areas.

In other words, the circuitry switches the multiple dummy discharge patterns in a predetermined order.

According to this configuration, since the switching order is determined in advance, the dummy discharge control is easily performed.

### Aspect 3

In the liquid discharge apparatus according to Aspect 2, the dummy discharge control unit performs the dummy discharge control while switching the selected dummy discharge pattern in the predetermined order in a subsequent reference number of non-image forming areas following the reference number of non-image forming areas.

In other words, the circuitry repeatedly switches the multiple dummy discharge patterns in the predetermined order.

According to this configuration, by repeatedly performing the operation of switching the multiple types of dummy discharge patterns in the predetermined order, periodic dummy discharge for each nozzle can be performed.

### Aspect 4

In the liquid discharge apparatus according to Aspect 3, the dummy discharge control unit performs the dummy discharge control so that dummy discharge is performed once every N/M times from each nozzle of the multiple nozzles up to the reference number of non-image forming areas, where N is the number of types of selected dummy discharge patterns that are switched in the predetermined order.

In other words, the circuitry causes the liquid discharge head to discharge the liquid from each of the multiple nozzles once during N×M non-image forming areas including the non-image forming areas, where N represents a number of the multiple dummy discharge patterns, and M represents the predetermined number of the non-image forming areas.

According to this configuration, the dummy discharge can be performed from each nozzle at a frequency of once in every N×M non-image forming areas.

### Aspect 5

The liquid discharge apparatus according to any one of Aspects 2 to 4, further includes a change unit (e.g., the controller 2) to change the type of the selected dummy discharge pattern, which is switched by the dummy discharge control unit in the predetermined order, based on predetermined change conditions.

In other words, the circuitry changes the multiple dummy discharge patterns to other multiple dummy discharge patterns based on predetermined change conditions.

According to this configuration, since the type of the selected dummy discharge pattern, which is switched in the predetermined order, can be changed, various problems can be prevented.

### Aspect 6

In the liquid discharge apparatus according to any one of Aspects 1 to 5, the multiple types of dummy discharge patterns include a dummy discharge pattern in which a dot interval of the liquid dummy-discharged onto the non-image forming area in a width direction of the recording medium orthogonal to the conveyance direction of the recording medium is one dot or more.

In other words, the circuitry forms each of the multiple dummy discharge patterns including a dot pattern including multiple dots formed at intervals corresponding to one dot or more in a width direction orthogonal to the conveyance direction and the discharge direction.

According to this configuration, a droplet of the liquid dummy-discharged does not land at a position (dot) next to the position (dot) at which another droplet lands in the width direction of the recording medium. As a result, droplets of the liquid dummy-discharged do not contact and merge with each other. Accordingly, the liquid dummy-discharged is likely to be quickly dried, and thus the liquid dummy-discharged is sufficiently dried and conveyed downstream in the conveyance direction of the recording medium. Thus, the liquid not sufficiently dried does not contact a conveyance member (e.g., the conveyance roller) on the downstream side in the conveyance direction, and the liquid does not adhere to the conveyance member. Accordingly, the deterioration of an image can be prevented.

Further, as described later, when the liquid discharge apparatus includes a dot pattern detector that detects a dot pattern on the non-image forming area formed of the liquid dummy-discharged, a relationship between a dot formed of the liquid dummy-discharged and the nozzle corresponding to the dot can be easily grasped based on the dot pattern detected by the dot pattern detector.

### Aspect 7

In the liquid discharge apparatus according to any one of Aspects 1 to 6, the multiple types of dummy discharge patterns include an dummy discharge pattern in which a position of a dot of the liquid dummy-discharged onto the non-image forming area is shifted in the conveyance direction of the recording medium from another dot closest to the dot in a width direction B of the recording medium orthogonal to the conveyance direction of the recording medium.

In other words, the circuitry forms each of the multiple dummy discharge patterns including a dot pattern including multiple dots in the non-image forming areas. The multiple dots include first dots and second dots: adjacent to the first dots in a width direction orthogonal to the conveyance direction and the discharge direction; and shifted from the first dots in the conveyance direction.

According to this configuration, the number of nozzles that perform the dummy discharge in one dummy discharge pattern can be increased while keeping the dot interval in the width direction of the recording medium between the dots of the liquid dummy-discharged. As a result, the frequency of the dummy discharge per nozzle can easily be set to be high.

### Aspect 8

The liquid discharge apparatus according to any one of Aspects 1 to 7, further includes a dot pattern detector (e.g., the in-line sensor of the image inspection device 4) that detects a dot pattern (e.g., the dummy discharge dot pattern) formed by the dummy discharge of the liquid on the non-image forming area.

In other words, the liquid discharge apparatus according to any one of Aspects 1 to 7, further includes a dot pattern detector to detect the multiple dummy discharge patterns.

According to this configuration, the dot pattern formed by the dummy discharge of the liquid on the non-image forming area can be used as a pattern for a purpose other than the dummy discharge, such as a pattern for detecting the presence or absence of a defective nozzle. As a result, the consumption of liquid can be reduced compared to the case where the pattern for detecting the presence or absence of a defective nozzle is formed separately from the dummy discharge pattern.

### Aspect 9

In the liquid discharge apparatus according to Aspect 8, the image forming device has a configuration in which multiple liquid discharge heads 100 that discharge liquids of different colors (e.g., Y, M, C, and K) are arranged in the conveyance direction A of the recording medium, and the multiple types of dummy discharge patterns include a dummy discharge pattern in which a dot interval of the liquid of the same color dummy-discharged onto the non-image forming area in a width direction B of the recording medium orthogonal to the conveyance direction of the recording medium is one dot or more.

In other words, the liquid discharge apparatus according to Aspect 8, further includes multiple liquid discharge heads including the liquid discharge head. The multiple liquid discharge heads are arranged in the conveyance direction and discharge the liquid of colors different from each other. The circuitry forms each of the multiple dummy discharge patterns including a dot pattern including multiple dots of the same color formed at intervals corresponding to one or more dots in a width direction orthogonal to the conveyance direction and the discharge direction.

According to this configuration, a relationship between a dot formed of the liquid dummy-discharged and the nozzle corresponding to the dot can be easily grasped based on the dot pattern detected by the dot pattern detector.

### Aspect 10

In the liquid discharge apparatus according to Aspect 8 or 9, the image forming device has a configuration in which multiple liquid discharge heads that discharge liquids of different colors are arranged in the conveyance direction of the recording medium, and a dot of the liquid of another color dummy-discharged is disposed between dots of the liquid of the same color dummy-discharged onto the non-image forming area in a width direction B of the recording medium orthogonal to the conveyance direction of the recording medium is one dot or more.

In other words, the liquid discharge apparatus according to Aspect 8 or 9, further includes multiple liquid discharge heads including the liquid discharge head. The multiple liquid discharge heads are arranged in the conveyance direction and discharge the liquid of colors different from each other. The circuitry forms each of the multiple dummy discharge patterns including a first dot pattern including first multiple dots of a first color of the colors and a second dot pattern including second multiple dots of a second color different from the first color. The second multiple dots are formed between the first multiple dots in a width direction orthogonal to the conveyance direction and the discharge direction.

According to this configuration, while the dot interval in the width direction B of the recording medium for the liquid of the same color to be dummy-discharged is widened, the length of the dummy discharge dot pattern in the conveyance direction of the recording medium can be prevented from being increased.

### Aspect 11

In the liquid discharge apparatus according to any one of Aspects 8 to 10, the image forming device has a configuration in which multiple liquid discharge heads that discharge liquids of different colors are arranged in the conveyance direction A of the recording medium. The multiple types of dummy discharge patterns include a dummy discharge pattern in which dots of the liquids of multiple colors (e.g., Y, M, and C) dummy-discharged are superimposed one on another at the same position.

In other words, the liquid discharge apparatus according to any one of Aspects 8 to 10, further includes multiple liquid discharge heads including the liquid discharge head. The multiple liquid discharge heads are arranged in the conveyance direction and discharge the liquid of colors different from each other. The circuitry forms each of the multiple dummy discharge patterns including a dot pattern including first multiple dots of a first color of the colors and second multiple dots of a second color different from the first color. The second multiple dots are formed on the first multiple dots.

According to this configuration, since the dots of the liquids of the multiple colors dummy-discharged can be superimposed at the same position, the length of the dummy discharge dot pattern in the conveyance direction of the recording medium can easily be set to be short. Even when the dots of the liquids of the multiple colors dummy-discharged are superimposed one on another at the same position, the defective nozzle can be specified based on the difference in the color values or lightness of the dot in the dummy discharge dot pattern detected by the dot pattern detector.

### Aspect 12

In the liquid discharge apparatus according to Aspect 11, the liquids of the multiple colors do not include black liquid.

In other words, the first color and the second color are colors other than black.

According to this configuration, even when the dots of the liquids of the multiple colors dummy-discharged are superimposed one on another at the same position, the defective nozzle can easily be specified based on the difference in the color values or lightness of the dot in the dummy discharge dot pattern detected by the dot pattern detector.

### Aspect 13

The liquid discharge apparatus according to Aspect 11 or 12, further includes a defective nozzle detector (e.g., the controller 2) that detects a nozzle of a color in which a discharge failure occurs among nozzles that perform the dummy discharge of the liquids of the multiple colors to the same position based on the color values or lightness of the dot pattern detected by the dot pattern detector.

In other words, the dot pattern detector detects a defective nozzle having a discharge failure among the multiple nozzles based on color values or lightness of the dot pattern.

According to this configuration, regarding the dots of the liquids of the multiple colors dummy-discharged and superimposed one on another at the same position, the nozzle of the color in which a discharge failure occurs can be detected based on the difference in the color values or lightness of the dot.

### Aspect 14

The liquid discharge apparatus according to any one of Aspects 1 to 13, the liquid discharge head is a flow-through head.

In other words, the liquid discharge head is a flow-through head including individual liquid chambers communicating with the multiple nozzles, respectively, and a common circulation channel through which the liquid in the individual liquid chambers is circulated.

According to this configuration, as a result of preventing the drying of the liquid in the nozzle, the frequency of the dummy discharge per nozzle can be set to be low. Thus, even in the dummy discharge pattern in which the dummy discharge is performed from a part of the nozzles in one non-image forming area (even when the frequency of the dummy discharge per nozzle is lower than that in the comparative example), the nozzle can be stably maintained and recovered.

According to one aspect of the present disclosure, even when the interval between the image forming areas in the conveyance direction of the recording medium is set to be narrow, the dummy discharge control can be appropriately performed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a conveyor to convey a recording medium in a conveyance direction;
a liquid discharge device including a liquid discharge head having multiple nozzles,
the liquid discharge head to discharge a liquid, in a discharge direction orthogonal to the conveyance direction, from the multiple nozzles onto the recording medium conveyed in the conveyance direction; and
circuitry configured to cause the liquid discharge head to:
discharge the liquid into each of image forming areas on the recording medium,
to form an image in each of the image forming areas to perform an image forming operation; and
discharge the liquid into every predetermined number of non-image forming areas between the image forming areas in the conveyance direction,
to form multiple dummy discharge patterns in each of the non-image forming areas to perform a dummy discharge operation;
select one of the multiple dummy discharge patterns to discharge the liquid from a part of the multiple nozzles to one of the non-image forming areas to perform a part of the dummy discharge operation;
switch the multiple dummy discharge patterns:
from the one of the multiple dummy discharge patterns;
to another of the multiple dummy discharge patterns,
to discharge the liquid from another part of the multiple nozzles to perform another part of the dummy discharge operation; and
alternately repeat:
the image forming operation; and
the dummy discharge operation,
to discharge the liquid from all the multiple nozzles with all the multiple dummy discharge patterns to complete one cycle of the dummy discharge operation.

2. The liquid discharge apparatus according to claim 1,
wherein the circuitry is further configured to:
alternately repeat:
the image forming operation; and
the dummy discharge operation,
a number of times equal to a number of the multiple dummy discharge patterns,
to discharge the liquid from all the multiple nozzles with all the multiple dummy discharge patterns to complete one cycle of the dummy discharge operation.

3. The liquid discharge apparatus according to claim 1,
wherein the circuitry is further configured to switch the multiple dummy discharge patterns in a predetermined order.

4. The liquid discharge apparatus according to claim 3,
wherein the circuitry is further configured to repeatedly switch the multiple dummy discharge patterns in the predetermined order.

5. The liquid discharge apparatus according to claim 4,
wherein the circuitry is further configured to cause the liquid discharge head to discharge the liquid from each of the multiple nozzles once in N×M non-image forming areas including the non-image forming areas,
where N represents a number of the multiple dummy discharge patterns, and
M represents the predetermined number of the non-image forming areas.

6. The liquid discharge apparatus according to claim 3,
wherein the circuitry is further configured to change the multiple dummy discharge patterns to other multiple dummy discharge patterns based on predetermined change conditions.

7. The liquid discharge apparatus according to claim 1,
wherein the circuitry is further configured to form each of the multiple dummy discharge patterns including a dot pattern including multiple dots formed at intervals corresponding to one dot or more in a width direction orthogonal to the conveyance direction and the discharge direction.

8. The liquid discharge apparatus according to claim 1,
wherein the circuitry is further configured to form each of the multiple dummy discharge patterns including a dot pattern including multiple dots in the non-image forming areas, and
the multiple dots include:
first dots; and
second dots:
adjacent to the first dots in a width direction orthogonal to the conveyance direction and the discharge direction; and
shifted from the first dots in the conveyance direction.

9. The liquid discharge apparatus according to claim 1, further comprising a dot pattern detector to detect the multiple dummy discharge patterns.

10. The liquid discharge apparatus according to claim 9, further comprising multiple liquid discharge heads including the liquid discharge head,
wherein the multiple liquid discharge heads:
are arranged in the conveyance direction; and
discharge the liquid of colors different from each other,
the circuitry is further configured to form each of the multiple dummy discharge patterns including a dot pattern including multiple dots of the same color formed at intervals corresponding to one or more dots in a width direction orthogonal to the conveyance direction and the discharge direction.

11. The liquid discharge apparatus according to claim 9,
further comprising multiple liquid discharge heads including the liquid discharge head,
wherein the multiple liquid discharge heads:
are arranged in the conveyance direction; and
discharge the liquid of colors different from each other,
the circuitry is further configured to form each of the multiple dummy discharge patterns including:
a first dot pattern including first multiple dots of a first color of the colors; and
a second dot pattern including second multiple dots of a second color different from the first color, and
the second multiple dots are formed between the first multiple dots in a width direction orthogonal to the conveyance direction and the discharge direction.

12. The liquid discharge apparatus according to claim 9,
further comprising multiple liquid discharge heads including the liquid discharge head,
wherein the multiple liquid discharge heads:
are arranged in the conveyance direction; and
discharge the liquid of colors different from each other,
the circuitry is further configured to form each of the multiple dummy discharge patterns including a dot pattern including:
first multiple dots of a first color of the colors; and
second multiple dots of a second color different from the first color, and
the second multiple dots are formed on the first multiple dots.

13. The liquid discharge apparatus according to claim 12,
wherein the first color and the second color are colors other than black.

14. The liquid discharge apparatus according to claim 12,
wherein the dot pattern detector detects a defective nozzle having a discharge failure among the multiple nozzles based on color values or lightness of the dot pattern.

15. The liquid discharge apparatus according to claim 1,
wherein the liquid discharge head is a flow-through head including:
individual liquid chambers communicating with the multiple nozzles, respectively; and
a common circulation channel through which the liquid in the individual liquid chambers is circulated.
